(19) United States
(12) Patent Application Publication
(10) Pub. No.: US 2024/0299130 A1
(43) Pub. Date: Sep. 12, 2024

(54) ENDODONTIC TOOL WITH A ROTATING TIP

(71) Applicant: King Faisal University, Al-Ahsa (SA)

(72) Inventor: Nazargi MAHABOB, Al-Ahsa (SA)

(21) Appl. No.: 18/117,602

(22) Filed: Mar. 6, 2023

(51) Int. Cl. A61C 5/42; A61C 1/05; A61C 1/12

(52) U.S. Cl. CPC A61C 5/42; A61C 1/052; A61C 1/12

(57) ABSTRACT

An integrated system and method for treating dental caries by an endodontic procedure which in a first embodiment deploys a handpiece fitted with an endodontic file with a rotating tip. The handpiece includes an elongated shaft including a turbine at a distal end of the elongated shaft such that the turbine provides a rotational force to the rotating tip.

### BACKGROUND

### 1. Field

The disclosure of the present patent application relates to a device, method, system, and/or apparatus for the treatment of dental caries.

### 2. Description of the Related Art

It is well known that a prevalent and persistent problem in maintaining dental health in a population, more particularly, in the younger demographic of children, is detection and subsequent treatment of dental caries. The expense of treatment alone exceeds the whole cost of providing healthcare for children in low-income nations. The quality of life, school attendance, eating habits, growth, and development of children are all impacted by this disease, which is present in all socioeconomic groups. Additionally, treatment of dental caries costs the global economy US $298 billion in direct treatment expenditures, 4.6% of the global health budget, and $144 billion in lost productivity.

If the dental caries are not treated initially, it may lead to either a pervasive infection of the tooth and/or total destruction of the tooth. The typical treatment solution provided for the extraction and replacement of the affected tooth, which is more expensive than if the tooth could be saved. This scenario was the solution before currently available endodontic treatments. Endodontic treatment is typically needed when the tooth nerve and pulp become inflamed or infected. Root canal or endodontic treatments are performed to save the tooth from an infection that is affecting the nerves in its root. This treatment also eliminates the pain experienced because of the infection.

The most advanced technology in endodontics currently available makes use of rotary endodontic instruments. In comparison with hand-held endodontic cleaning instruments, these rotary instruments are fast and help save time. But the problem with both techniques is that excessive force can break the instrument in the root canal. After breaking either the file or reamer's part, the fragment becomes stuck in the root canal and becomes more problematic. This problem arises because of the fundamental principle followed in both hand and rotary techniques: the rotating force is applied from the outside and the entire instrument is rotating. If the tip of the instrument is struck in the canal due to the torque induced by the external force, the endodontic instrument breaks up.

Accordingly, a way to safely deploy a tool such as an endodontic file with a rotating tip can be used to hollow out the root canal without the tool breaking off within the root canal due to application of excessive force. The present subject matter addresses such needs.

### SUMMARY

The present subject matter relates to an integrated system and method for treating dental caries by an endodontic procedure which in a first embodiment deploys a handpiece fitted with an endodontic file with a rotating tip. Ensuring that only the tip is capable of rotation, rather than the shaft or the body of the tool, the tip is driven to rotate by a distal situated turbine. The tool has a main body, and the head is substantially perpendicular to the main body. The main body may be in the form of an elongated shaft.

In certain embodiments, in use, a turbine-driven small nano head can be placed in the tip of the root canal to be treated. This rotating head will help remove the unwanted tissues and blocking structures. It also helps shape the canal. This rotating head draws its entire force from the rotating turbine placed in the tip of the endodontic instrument. These turbines are driven by fast-moving, pressured water or saline. In this technique, only the tip of the instrument rotates not the entire shaft or instrument. This will prevent endodontic instrument breakage inside the root canal, and, simultaneously, the canal will be irrigated with outflowing water or saline. The rotating driller head can be changed with different types of driller heads based on the specific need.

These and other features of the present subject matter will become readily apparent upon further review of the following specification.

### BRIEF DESCRIPTION OF THE DRAWINGS

FIG. 1 is a side view of the handpiece with the embodiment of the endodontic file with the rotating tip;

FIG. 2 is a side view of a handpiece with a conventionally used endodontic file;

FIG. 3a is a side view of a handpiece with a conventionally used endodontic file as deployed within a tooth;

FIG. 3b is a side view of conventional endodontic files;

FIG. 4a is a side view of handpiece with the endodontic file with a rotating tip;

FIG. 4b is a close up view of the turbine inside the shaft of the handpiece;

FIG. 4c is a close up view of the turbine connected with the driller head; and

FIG. 4d is a close up front view of the turbine head.

Similar reference characters denote corresponding features consistently throughout the attached drawings.

### DETAILED DESCRIPTION OF EMBODIMENTS

Throughout the application, where a system, apparatus, or the like are described as having, including, or comprising specific components, or where processes or methods are described as having, including, or comprising specific process or method steps, it is contemplated that the present teachings can also consist essentially of, or consist of, the recited components, and that the processes of the present teachings can also consist essentially of, or consist of, the recited process steps.

It is noted that, as used in this specification and the appended claims, the singular forms “a”, “an”, and “the” include plural references unless the context clearly dictates otherwise.

The use of the terms “include,” “includes”, “including,” “have,” “has,” or “having” should be generally understood as open-ended and non-limiting unless specifically stated otherwise.

The use of the singular herein includes the plural (and vice versa) unless specifically stated otherwise. In addition, where the use of the term “about” is before a quantitative value, the present teachings also include the specific quantitative value itself, unless specifically stated otherwise. As used herein, the term “about” refers to a ±10% variation from the nominal value unless otherwise indicated or inferred.

The term “optional” or “optionally” means that the subsequently described event, circumstance, or component may or may not occur, or may or may not be present and that the description includes instances where said event or circumstance occurs and instances in which it does not.

Throughout the application, descriptions of various embodiments use “comprising” language. However, it will be understood by one of skill in the art, that in some specific instances, an embodiment can alternatively be described using the language “consisting essentially of” or “consisting of”.

For purposes of better understanding the present teachings and in no way limiting the scope of the teachings, unless otherwise indicated, all numbers expressing quantities, percentages or proportions, and other numerical values used in the specification and claims, are to be understood as being modified in all instances by the term “about”. Accordingly, unless indicated to the contrary, the numerical parameters set forth in the following specification and attached claims are approximations that may vary depending upon the desired properties sought to be obtained. At the very least, each numerical parameter should at least be construed in light of the number of reported significant digits and by applying ordinary rounding techniques.

The integrated system and method for treating dental caries by deploying a handpiece with an attached endodontic file with a rotating tip is provided herewith as a tool to mainly remove infected pulp and nerves within the root canal.

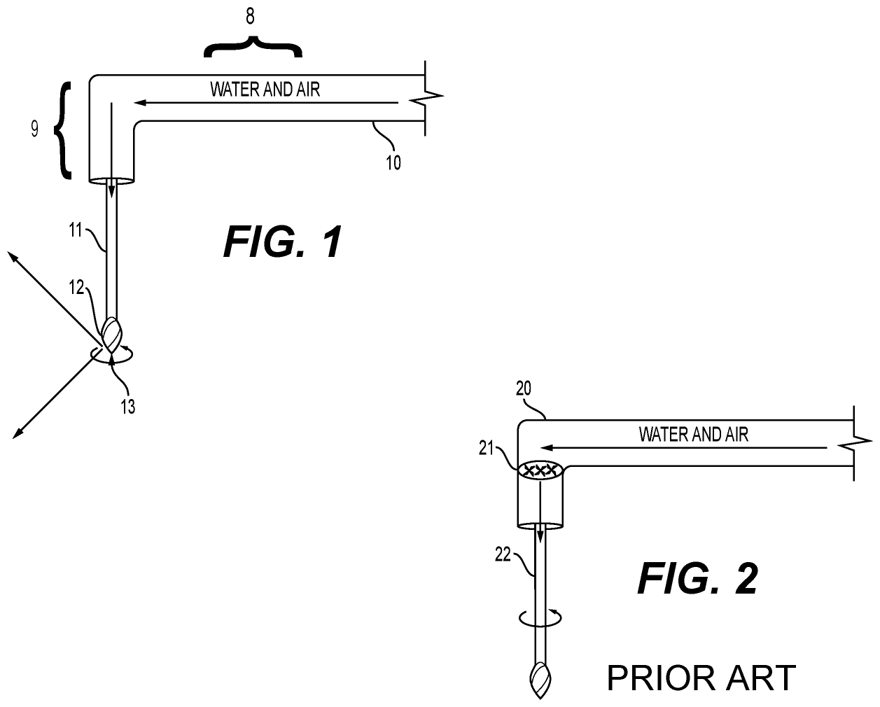

FIG. 1 shows a handpiece (10) which comprises a generally L-shaped housing, having a first section 8 and a second section 9, with an elongated shaft (11) that extends from the handpiece (10). In certain embodiments, the elongated shaft (11) can be flexible to allow for axial manipulation as it penetrates the aperture of the root canal. At the distal end of the elongated shaft (11) is a turbine (12) which rotates about the axis of the elongated shaft and translates its rotational force to a driller head (13) which is attached to the turbine (12). The turbine (12) can be driven by a dual stream of pressurized air and pressurized water or saline provided from a lone conduit that traverses the length of the handpiece (10) and the attached elongated shaft (11). Switches on the handpiece (10) control the flow of the dual stream pressurized air and pressurized water or saline to the turbine (12) such that a change in the flow of the dual pressurized streams also affects the rotational speed of the turbine (13).

The advantages of this design are three-fold. By restricting the location of the rotational force to the distally situated turbine (12) and attached driller head (13), the occurrence of tool breakage, such as in a conventional endodontic file, is greatly reduced. Secondly, by using the dual pressurized stream of air and water or saline, the turbine can be driven, and the stream can be ejected to the drilling point providing irrigation of the root canal area by flushing out the accumulated debris of the drilling operation. And lastly, the dual pressurized stream can also provide a cooling effect near the cutting surface of the driller head (13).

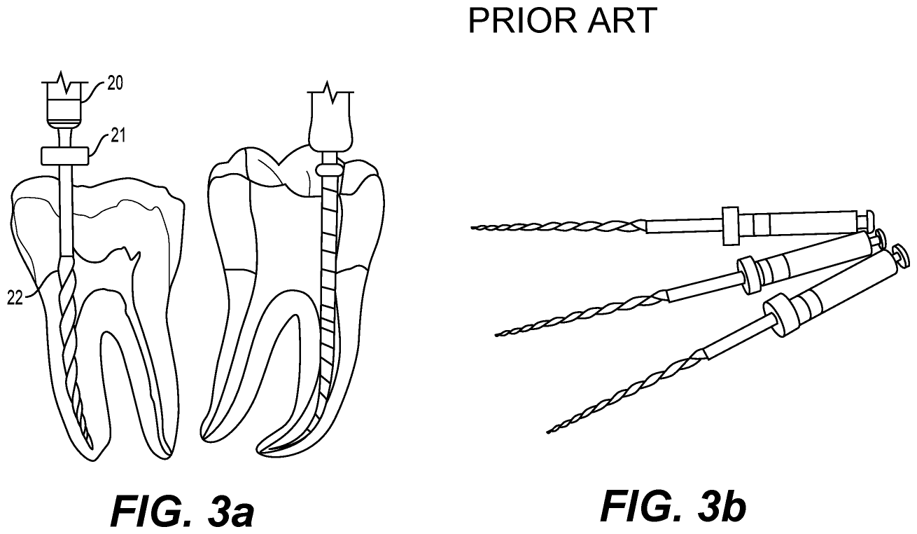

As seen in FIG. 2, a conventional handpiece (20) with an endodontic file (22) is shown. The turbine (21) is placed within the generally L-shaped handpiece (20) and the turbine (21) is used to rotationally drive the endodontic file (22). The pressurized streams of air, water, and/or saline that are provided are deployed over a wider area than the more focused and targeted ejection points within the driller head of the present handpiece and endodontic file with a rotating tip of FIG. 1. The disadvantage of this conventional design is that the entire file (22) rotates, causing undue torque up and down the elongated body of the file (22), which can cause it to warp and break. Since the water and/or saline has to come to the drilling area from the end of the handpiece holes, the likelihood of debris accumulation is high. Additionally, the file (22) has to be removed for irrigation purposes. As shown in FIG. 3, due to the curvature of the root canal, the inserted file (22) will also have to bed while rotating during the drilling operation leading to a higher likelihood of file breakage.

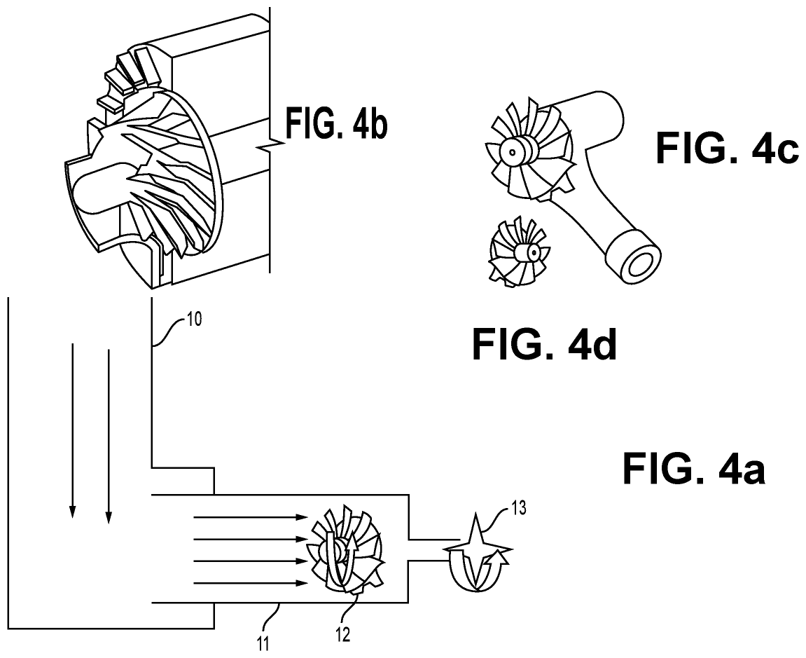

FIG. 4 shows an additional side view of the present generally L-shaped handpiece (10) and elongated shaft (11) with the turbine (12) and driller head (13). The turbine (12) can comprise or consist of a collection of radially disposed fins which one end of each fin angled upwards from the horizontal plane of each fin. The dual stream of pressurized air and water or saline strikes each respective upward portion of each fin of the turbine (12) causing the turbine to spin rotationally. This rotational motion is transferred to the attached driller head (13) which performs the drilling operation.

It is to be understood that the integrated system and method for treating dental caries by an endodontic procedure which deploys a handpiece fitted with a endodontic file with a rotating tip provided herewith is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. An integrated system for treating dental caries by an endodontic procedure which deploys a handpiece fitted with an endodontic file with a rotating tip, comprising:
a handpiece having a first section that is perpendicular to a second section, wherein said second section is shorter in length than said first section and wherein said first section and said second section are joined in a general L-shape configuration;
an elongated shaft which connects to said second section of said handpiece and extends away perpendicularly from said first section of said handpiece;
a circular turbine mounted on a distal end of said elongated shaft wherein said turbine rotates independently from said elongated shaft; and
a driller head mounted to a second side of said circular turbine wherein said driller head is caused to rotate by said circular turbine,
wherein the circular turbine has a collection of radially disposed fins, and
wherein each of the radially disposed fins has an upward section which extends away from a horizontal plane of each of the radially disposed fins.

2. The integrated system for treating dental caries by an endodontic procedure which deploys a handpiece fitted with an endodontic file with a rotating tip, as recited in claim 1, wherein the turbine is caused to rotate by a dual stream of pressurized air and pressurized water and/or saline.

3. The integrated system for treating dental caries by an endodontic procedure which deploys a handpiece fitted with an endodontic file with a rotating tip, as recited in claim 2, wherein the dual stream of pressurized air and pressurized water and/or saline is delivered to a first side of the circular turbine by a conduit which traverses the length of the first section and the second section of the handpiece.

4. (canceled)

5. (canceled)

6. The integrated system for treating dental caries by an endodontic procedure which deploys a handpiece fitted with an endodontic file with a rotating tip, as recited in claim 3, wherein said dual stream of pressurized air and pressurized water and/or saline is ejected from said driller head in order to flush out debris and cool the driller head during usage.

7. The integrated system for treating dental caries by an endodontic procedure which deploys a handpiece fitted with an endodontic file with a rotating tip, as recited in claim 6, wherein said first section of the handpiece has switches for controlling delivery of a flow rate of said dual stream of pressurized air and pressurized water and/or saline and for controlling operation of said distal circular turbine.

8. A method for treating dental caries by an endodontic procedure which deploys a handpiece fitted with an endodontic file with a rotating tip, comprising:
providing a handpiece having a first section that is perpendicular to a second section, wherein said second section is shorter in length than said first section and wherein said first section and said second section are joined in a general L-shape configuration;
providing an elongated shaft which connects to said second section of said handpiece and extends away perpendicularly from said first section of said handpiece;
causing a circular turbine mounted on a distal end of said elongated shaft to rotate independently from said elongated shaft;
causing a driller head mounted to a second side of said circular turbine to rotate; and
inserting the driller head into a mouth of a patient in need thereof to treat the dental caries,
wherein the circular turbine has a collection of radially disposed fins, and
wherein each of the radially disposed fin has an upward section which extends away from a horizontal plane of each of the radially disposed fins.

9. The method of claim 8, wherein the circular turbine is caused to rotate by a dual stream of pressurized air and pressurized water and/or saline.

10. The method of claim 9, wherein the dual stream of pressurized air and pressurized water and/or saline is delivered to a first side of the circular turbine by a conduit which traverses the length of the first section and the second section of the handpiece.

11. (canceled)

12. (canceled)

13. The method of claim 9, wherein said dual stream of pressurized air and pressurized water and/or saline is ejected from said driller head in order to flush out debris and cool the driller head during usage.

14. The method of claim 13, wherein said first section of the handpiece has switches for controlling delivery of a flow rate of said dual stream of pressurized air and pressurized water and/or saline and for controlling operation of said distal circular turbine.
